(19) United States
(12) Patent Application Publication
(10) Pub. No.: US 2003/0127155 A1
(43) Pub. Date: Jul. 10, 2003

(54) Connectivity device

(76) Inventors: Alan John Mulvenna, North Vancouver (CA); John David Trevor Graham, Vancouver (CA); William Edward Mufford, Langley (CA); Darren Scott Sokoloski, Burnaby (CA); Craig James Greenhill, Richmond (CA); Bruce Conrad Wilnechenko, Burnaby (CA); Curtis Michael Robin, Vancouver (CA); Matthew Albert MacLennan Harper, Vancouver (CA); Theodore Douglas Yntema, Vancouver (CA)

Correspondence Address: Paul F. Rusyn, Esq., DORSEY & WHITNEY LLP, Suite 3400, 1420 Fifth Avenue, Seattle, WA, 98101, US

(21) Appl. No.: 10/158,388

(22) Filed: May 29, 2002

Related U.S. Application Data
(60) Provisional application No. 60/347,585, filed on Jan. 10, 2002.

(51) Int. Cl. B65B 3/04; B67C 3/02; B65B 1/04

(52) U.S. Cl. 141/98

(57) ABSTRACT

This invention relates to a connectivity device for passively connecting a vehicle to a service port. The connectivity device comprises a mount for mounting to one of the vehicle or service port; a deployment apparatus movably attached to the mount; a plug for coupling to a receptacle in the other of the vehicle or service port; and, a compliant member attaching the plug to the deployment apparatus. The compliant member provides sufficient compliance for the plug to engage the receptacle when the connectivity device is in range of but not perfectly aligned with the receptacle.

### RELATED APPLICATIONS

This application claims priority from U.S. provisional patent application No. 60/347,585 “Method and System For Bi-Directional Conveyance of Electricity, Data, Liquids and Gases Between Vehicles and Stationary Service Ports” to Graham et al., filed on Jan. 10, 2002 and from U.S. patent application “Wheel Stop Service Port” to Graham et al., filed on May 10, 2002, which claims priority from U.S. provisional application No. 60/347,585, and U.S. provisional application No. 60/290,587 “Method and System For Bi-Directional Conveyance of Electricity, Data, Liquids and Gases Between Vehicles and Stationary Service Ports” to Graham et al., filed on May 11, 2001.

This application further references the US patent application “Service Coupling” to Mulvenna et al., and U.S. patent application “Service Coupling Configuration” to Mulvenna et al., filed concurrently with this application.

### FIELD OF THE INVENTION

This invention relates generally to connectors, and in particular to a connector for connecting one device to another, wherein at least one of the devices is a vehicle.

### BACKGROUND OF THE INVENTION

In today's world, motor vehicles such as automobiles, trucks, and motorcycles are typically powered by internal combustion engines. In these vehicles, a liquid fossil fuel such as gasoline is ignited to transform the chemical energy in the fuel into mechanical energy that is used to drive the vehicle. Due to the scarcity of fossil fuels and the pollution from vehicles burning these fuels, alternative fuels and new vehicles powered by these alternative fuels are being developed. For example, new types of vehicles that utilize gaseous fuels are being developed and are expected to enter commercial production within the next decade.

One type of gaseous fuel powered vehicle is a fuel cell vehicle (FCV), which uses a fuel cell to electrochemically generate electricity from hydrogen fuel and uses the electricity to power the vehicle. FCVs may use pure hydrogen delivered directly from a hydrogen fueling station, or may extract hydrogen from a hydrogen-containing fuel. In the latter case, a service terminal may for example, transmit a hydrogen-containing liquid such as methanol to the FCV, for reforming into hydrogen by an on-board methanol reformer. As another example, the FCV may have an on-board electrolyzer that uses electrolysis to extract hydrogen from water molecules supplied to the vehicle by the service terminal.

Because the FCV has different servicing requirements than gasoline-powered vehicles and because no FCV has yet to enter full-scale commercial production, no FCV servicing system is known to exist. Such an FCV servicing system would require service terminals that are configured to service FCVs; for example, an FCV service terminal may have a service port that connects to an FCV and facilitates the exchange of fuel, electricity and possibly data between the FCV and the service port. Providing such an FCV service terminal presents many challenges, including providing cost-effective and efficient systems for connecting the FCV to the service port.

### SUMMARY OF THE INVENTION

According to one aspect of the invention, there is provided a connectivity device for connecting a vehicle to a service port. The connectivity device includes a mount for mounting the connectivity device to one of the vehicle and the service port; a deployment apparatus movably attached to the mount; a plug for coupling to a receptacle in the other of the vehicle and the service port; and a compliant member attaching the plug to the deployment apparatus. The compliant member provides sufficient compliance for the plug to engage the receptacle after movement by the deployment apparatus and when the connectivity device is in range of but not aligned with the receptacle.

The mount may be configured to mount to the vehicle, and in such case the receptacle is configured to mount on the service port.

The compliant member may include a flexible electrical conductor for transmitting electricity between the vehicle and the service terminal. The compliant member may also include a flexible fluid conduit for transmitting fluid between the vehicle and the service terminal. The fluid conduit may be a water conduit, or, a hydrogen gas conduit, or both.

The compliant member may instead include a flexible festoon cable including an electrical conductor and a jacket housing the conductor. The compliant member may also further include a flexible fluid conduit. In such case, the fluid conduit may be flexible PVDF tubing.

The mount may comprise a mounting plate and a mount compliant member attached to the mounting plate and attachable to the vehicle. The mount compliant member may include at least one spring.

According to another aspect of the invention, there is provided a system for connecting a vehicle to a service port. The system includes a connection bay assembly in one of the vehicle or service port, and a connectivity device in the other of the vehicle or service port. The connection bay assembly includes a connection bay including a connection bay opening, a receptacle opening, and tapered walls tapering from the connection bay opening to the receptacle opening; and, a receptacle connected to the receptacle opening. The connectivity device includes a mount for mounting the connectivity device to the other of the vehicle and the service port; a deployment apparatus movably attached to the mount; a plug for coupling to the receptacle; and a compliant member that attaches the plug to the deployment apparatus. The compliant member provides sufficient compliance for the plug to comply with the tapered walls then engage the receptacle after movement by the deployment apparatus and when the connectivity device is in range of but not aligned with the receptacle.

The connectivity device may further include a docking bay attachable to the vehicle and for storing the plug when the connectivity device is in a retracted position. The connectivity device may also include an internal controller communicative with the deployment apparatus and one of a wireless transceiver and vehicle controller, for controlling the movement of the deployment apparatus.

According to another aspect of the invention, the compliant member may extend between the plug and the deployment apparatus; in such case, the compliant member includes an electrical conductor electrically coupled to the plug, and the deployment apparatus includes a conductive screw electrically coupled to the conductor and couplable to the vehicle, such that an electrical path is formed between the plug and the deployment apparatus. Instead of a conductive screw, the deployment apparatus may include a conductive strip electrically couplable to the vehicle and a contact element in sliding contact with the strip and electrically coupled to the compliant member conductor.

According to yet another aspect of the invention, the connectivity device may further include a telescoping fluid tube assembly that is fluid coupled at one end to the plug and fluid couplable at the other end to the vehicle, such that a fluid is transferable through the connectivity device.

### DETAILED DESCRIPTION OF DRAWINGS

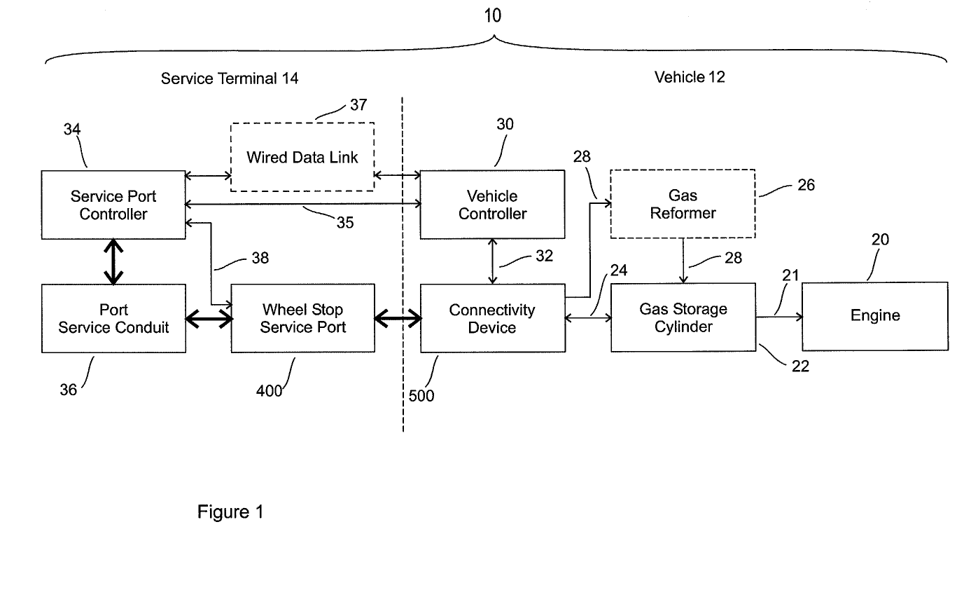

FIG. 1 is a system block diagram of a service terminal and a terminal-compatible vehicle, wherein a gaseous fuel and data are exchangeable between the service terminal and vehicle.

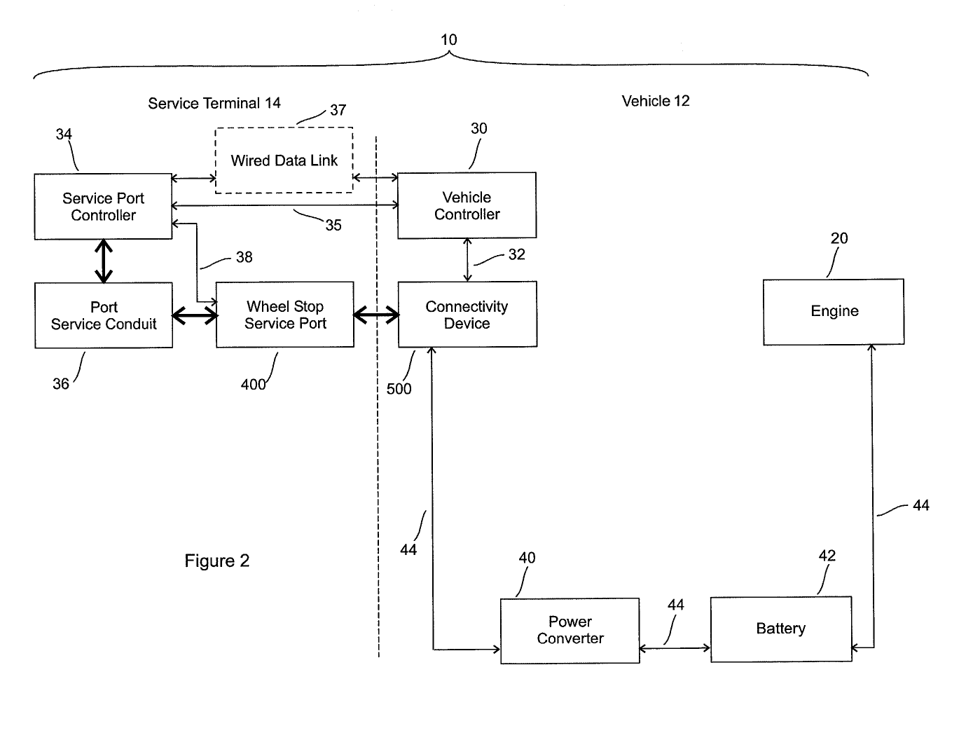

FIG. 2 is a system block diagram of a service terminal and a terminal-compatible vehicle, wherein electricity and data are exchangeable between the service terminal and vehicle.

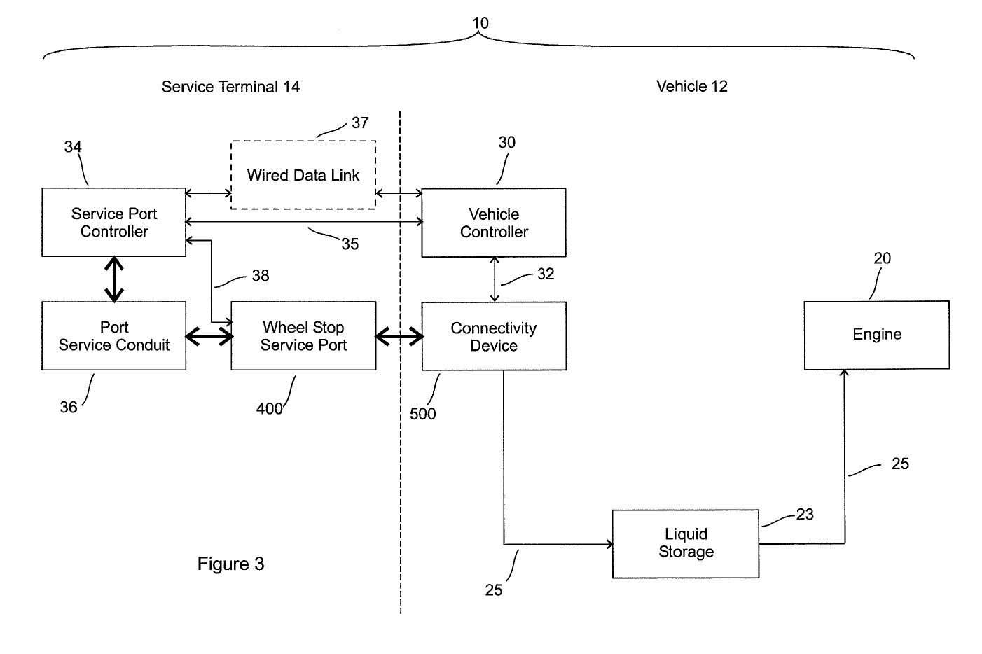

FIG. 3 is a system block diagram of a service terminal and a terminal-compatible vehicle, wherein liquid fuel and data are exchangeable between the service terminal and vehicle.

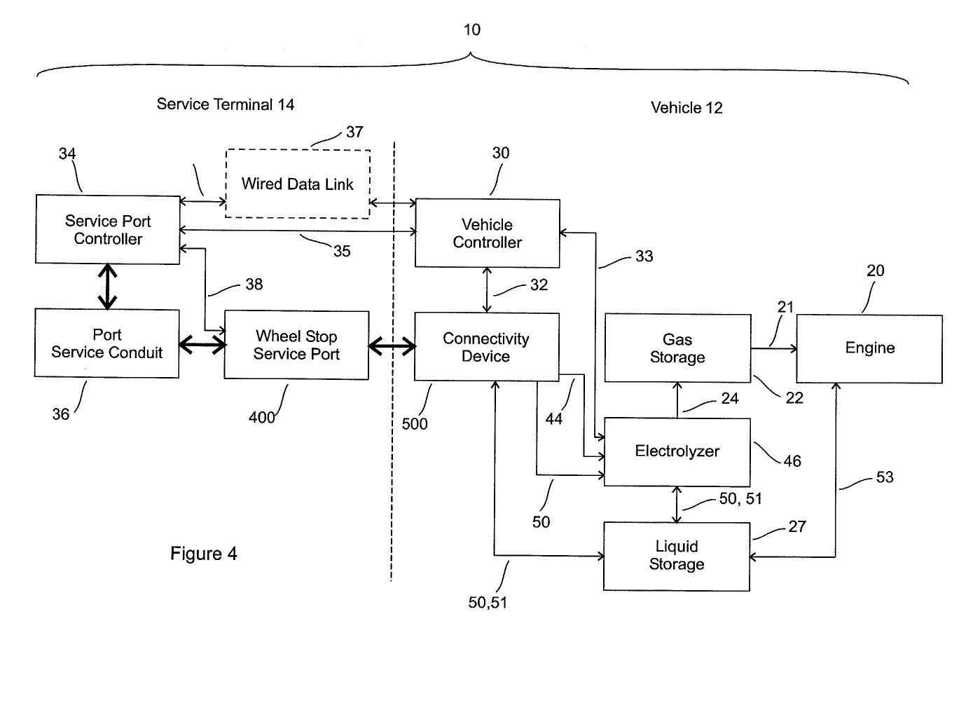

FIG. 4 is a system block diagram of a service terminal and a terminal-compatible vehicle, wherein water, electricity and data are exchangeable between the service terminal and vehicle.

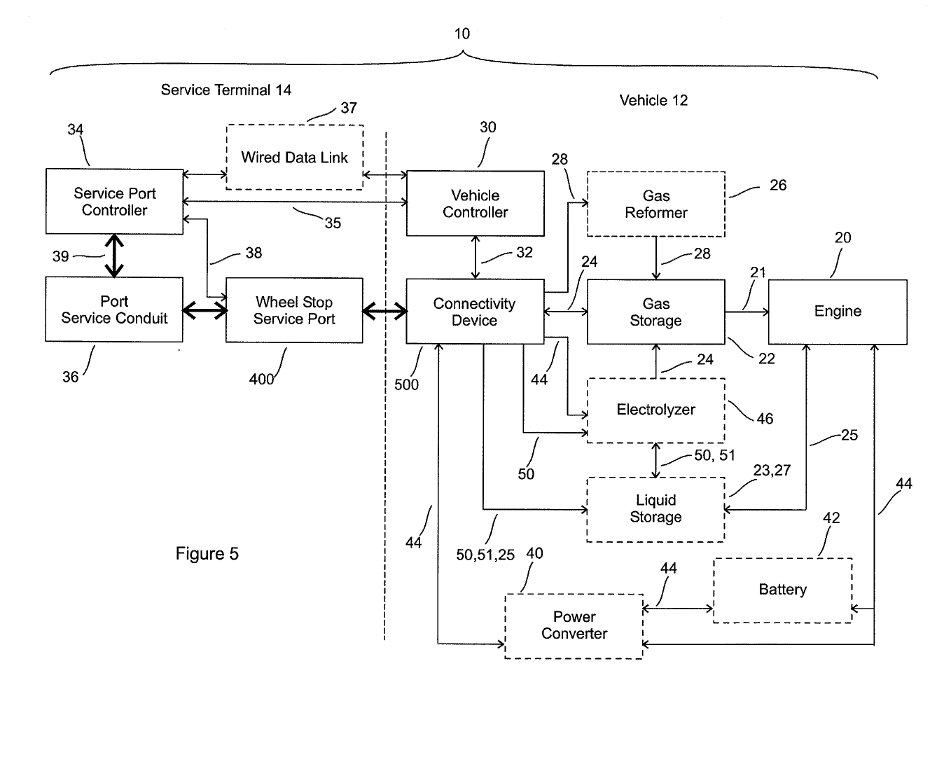

FIG. 5 is a system block diagram of a service terminal and a terminal-compatible vehicle, wherein liquid and gaseous fuels, water, electricity and data are exchangeable between the service terminal and vehicle.

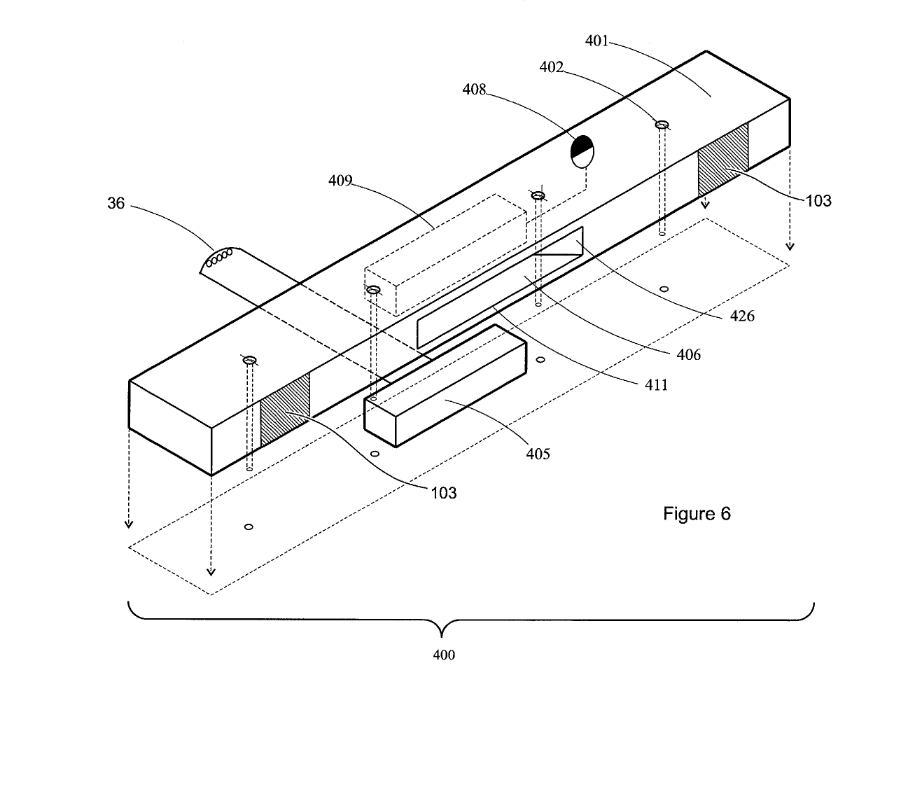

FIG. 6 is a perspective view of a wheel stop service port of the service terminal in FIGS. 1 to 5.

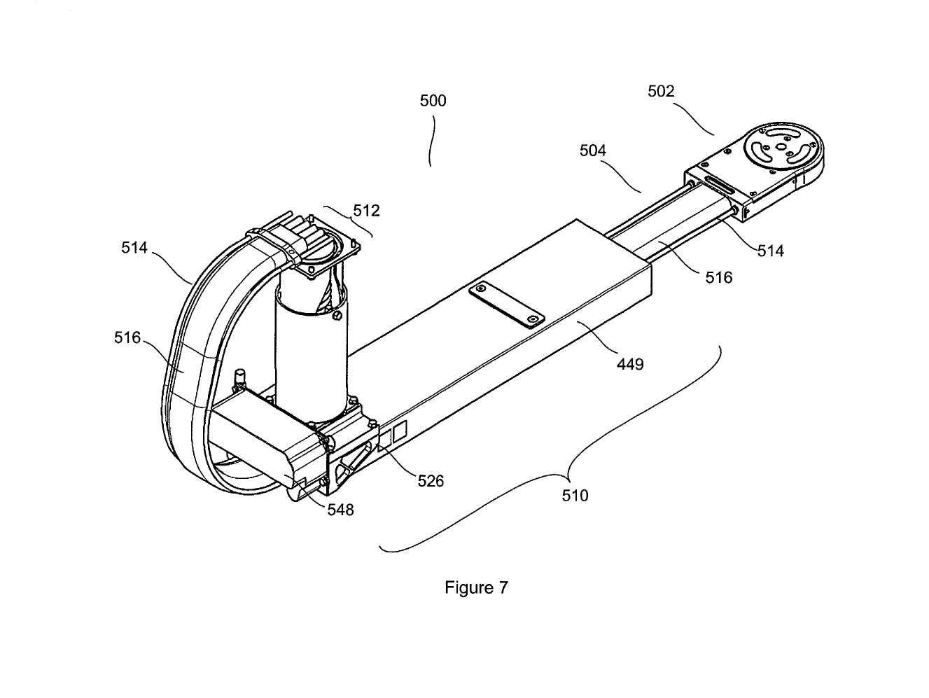

FIG. 7 is a perspective view of a connectivity device for mounting to a vehicle.

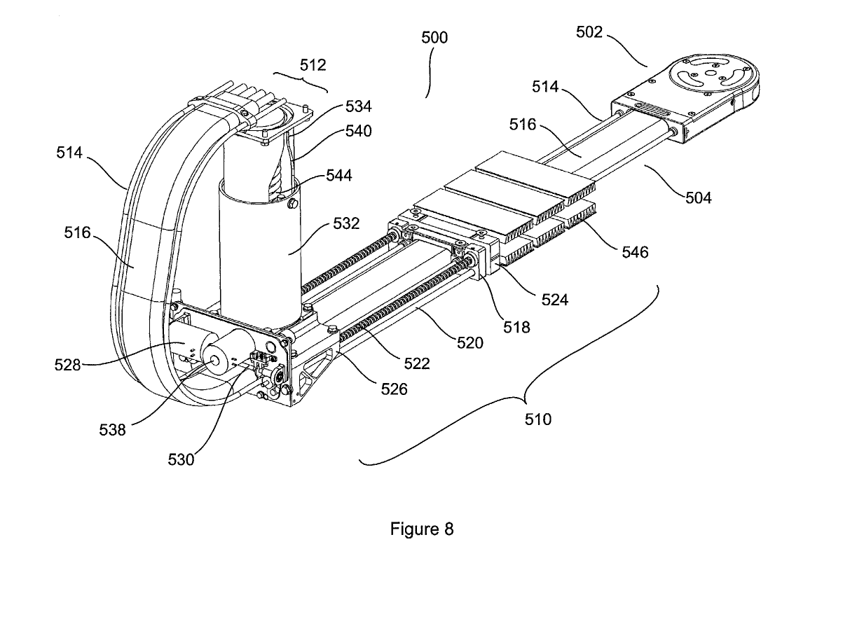

FIG. 8 is a perspective view of the connectivity device of FIG. 1 with a horizontal extension arm housing and motor housing removed to show internal components.

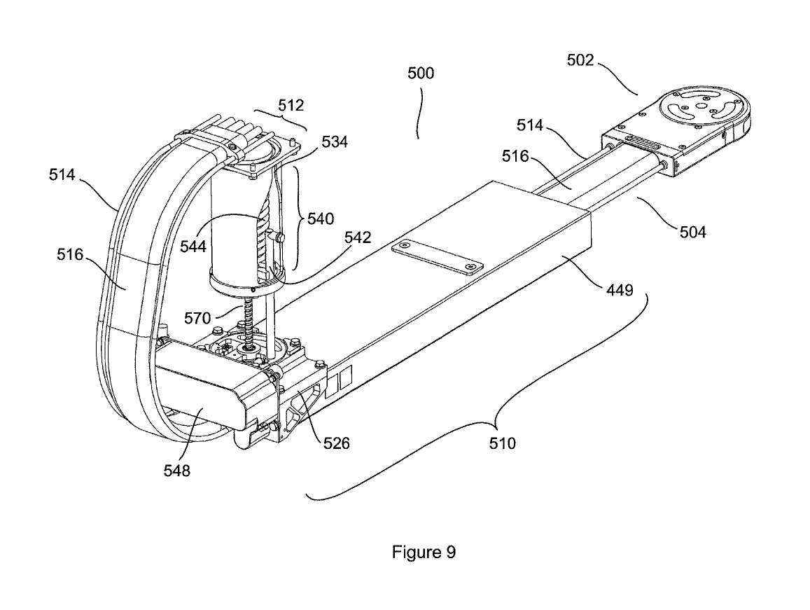

FIG. 9 is a perspective view of the connectivity device of FIG. 1 with a vertical extension arm housing removed to show internal components.

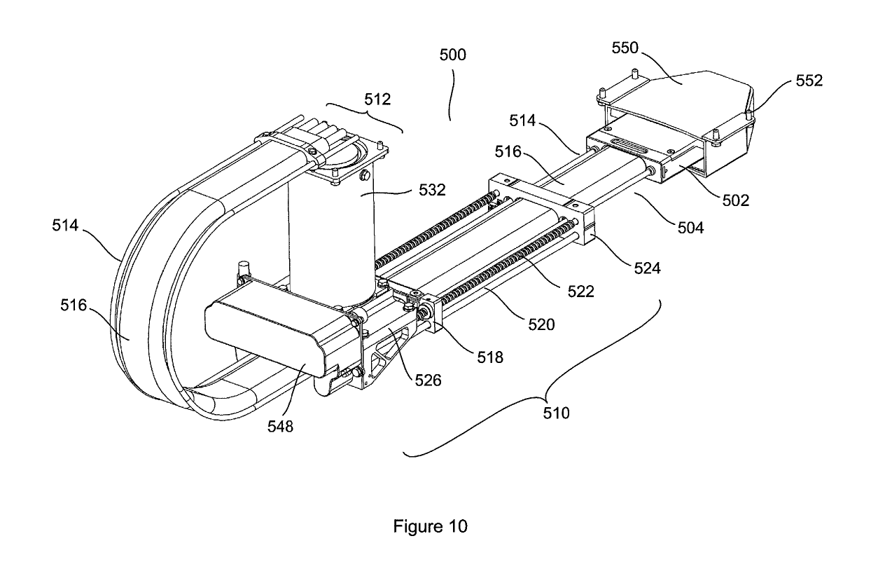

FIG. 10 is a perspective view of the connectivity device of FIG. 1 with the horizontal extension arm housing removed and the plug stored in a plug storage bay.

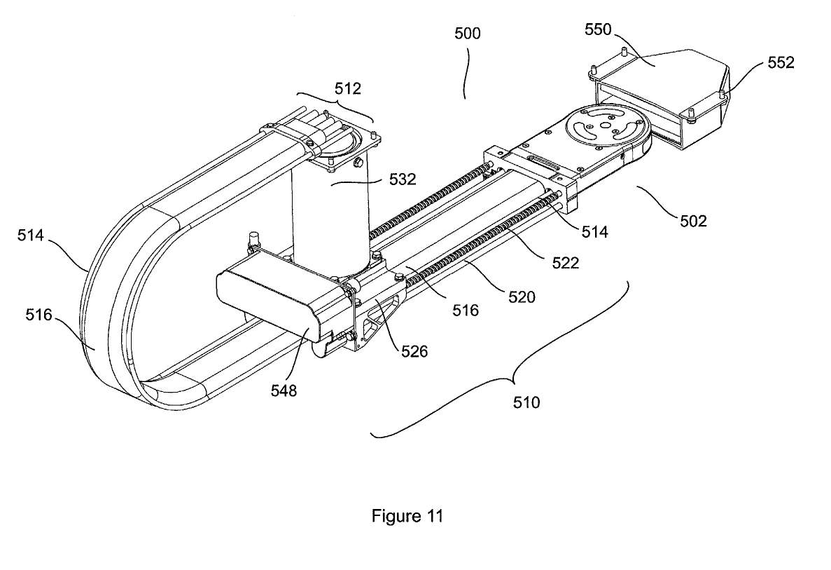

FIG. 11 is a perspective view of the connectivity device of FIG. 1 with the horizontal extension arm housing removed and the plug withdrawn from the storage bay.

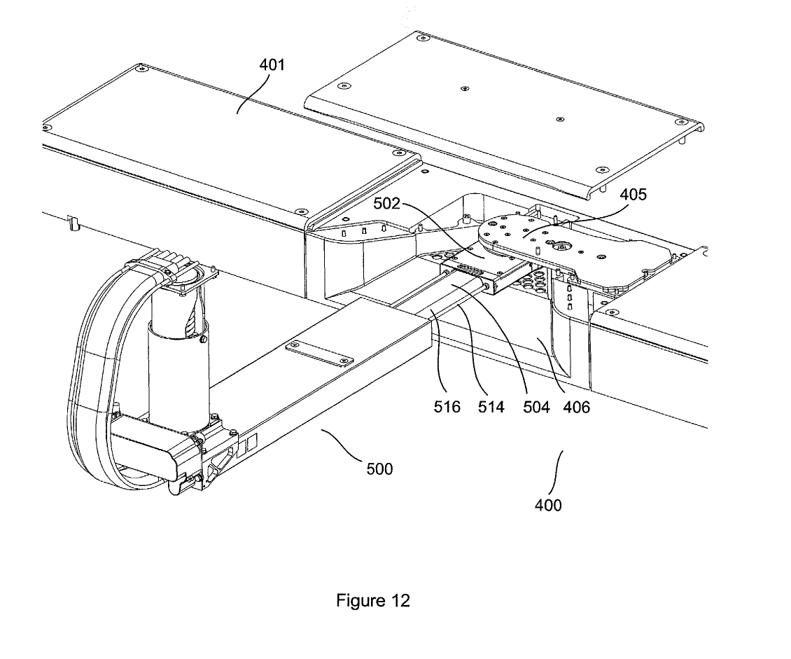

FIG. 12 is a perspective view of the connectivity device of FIG. 1 coupled to a wheel stop service port.

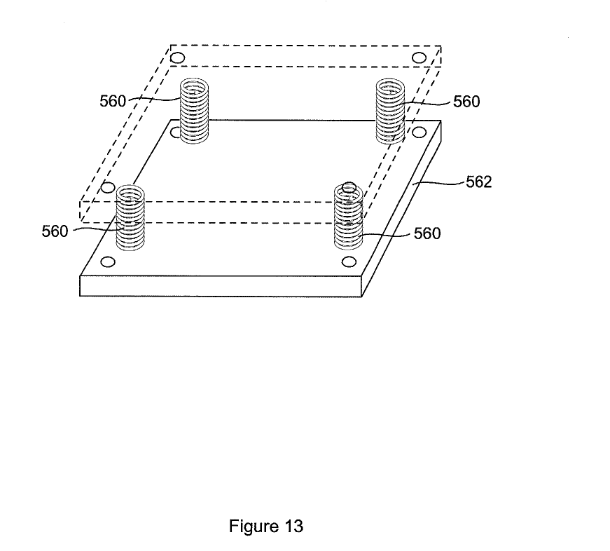

FIG. 13 is a perspective view of one embodiment of a compliant vehicle mounting assembly of the connectivity device.

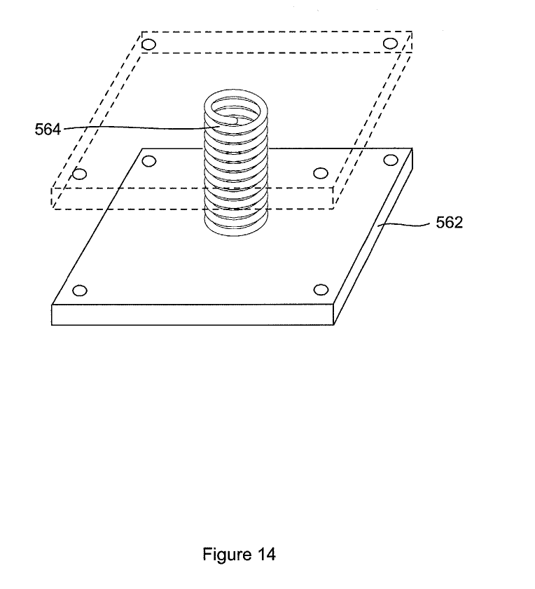

FIG. 14 is a perspective view of another embodiment of a compliant vehicle mounting assembly of the connectivity device.

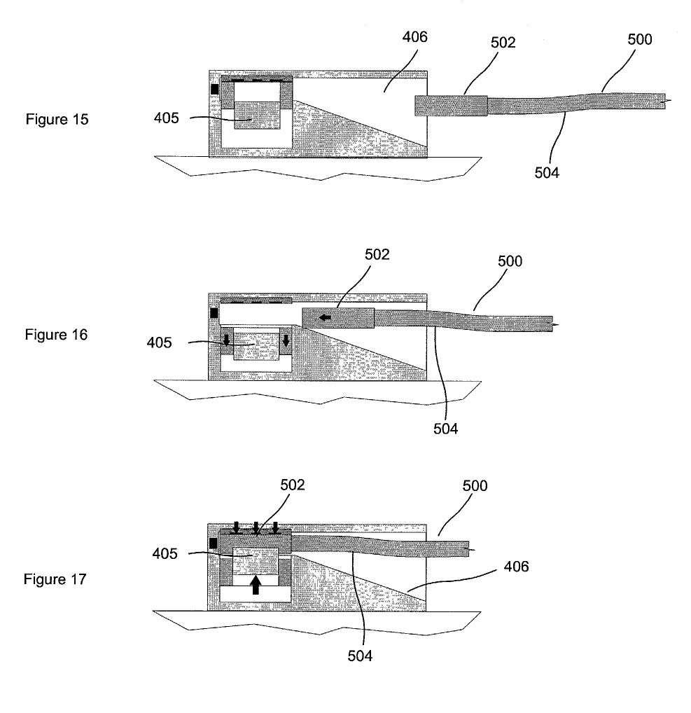

FIGS. 15 to 17 illustrate the steps of coupling a plug to a receptacle by a connectivity device that is not perfectly aligned with a service port.

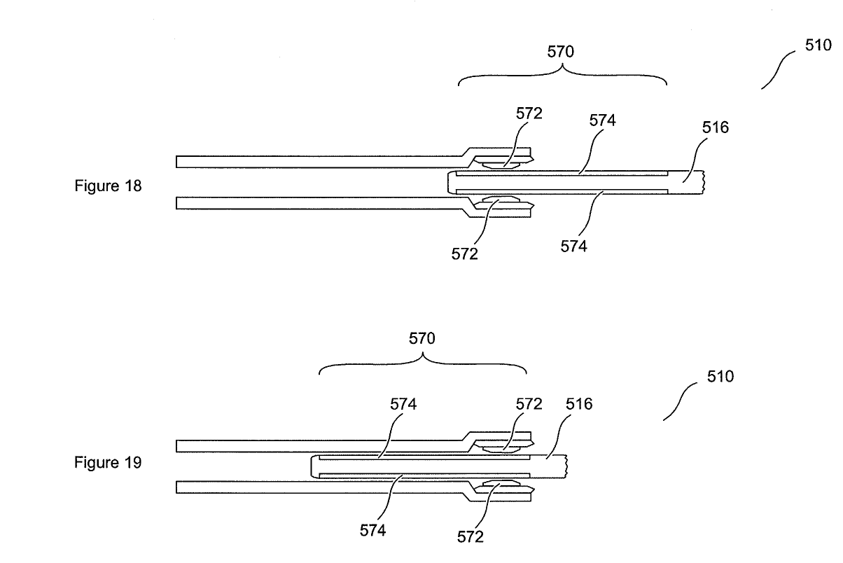

FIGS. 18 and 19 are side elevation views of a sliding electrical contact.

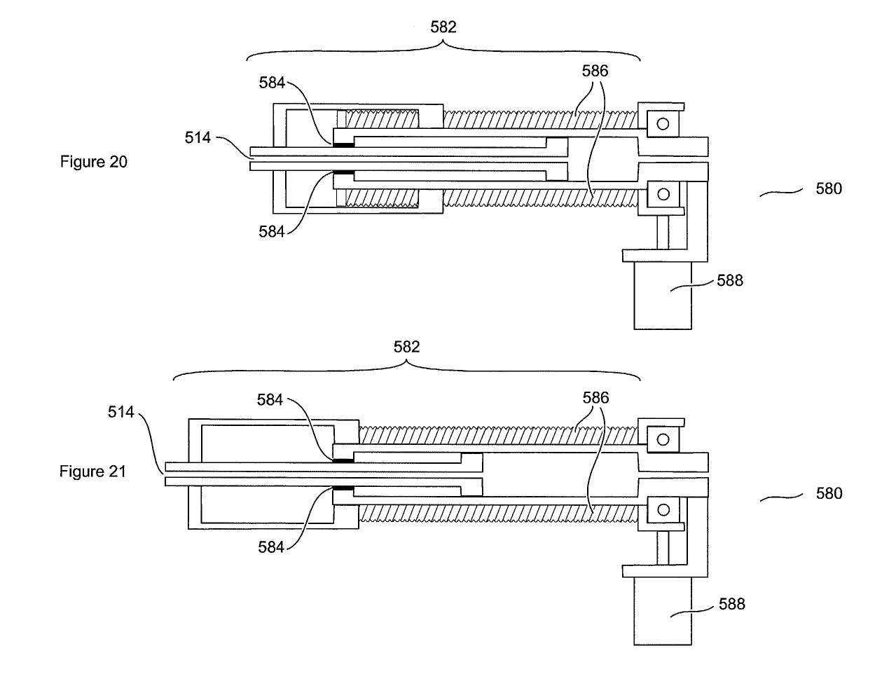

FIGS. 20 and 21 are side elevation views of a telescoping fluid tube.

### DETAILED DESCRIPTION

FIGS. 1-5 illustrate different embodiments of a system 10 for transferring one or more of energy, material or data (collectivity referred to as “services”) between system-compatible vehicles 12 and a stationary service terminal 14. The service terminal 14 may be integrated into a building or pre-existing structure, or be part of a dedicated vehicle service terminal building. In each embodiment, the service terminal 14 has a wheel stop service port 400 and the vehicle 12 has a connectivity device 500 that can couple to the wheel stop service port 400. Other major components of the service terminal 14 include a service port controller 34 for controlling the transfer of services by the wheel stop service port 400, and a port service conduit 36 for coupling the service terminal 14 to one or more service destinations (not shown). The destination may be a service source when the service is to be transferred from the source to the vehicle 12; for example, the service source may be a fuel tank that supplies fuel to the vehicle 12 when coupled to the service terminal 14. Or, the destination may be a service consumer when the service is to be transferred from the vehicle 12 to the consumer; for example, the service terminal 14 may be connected to a power grid, and the consumer may be an electricity user connected to the grid that receives electricity generated by a fuel cell onboard the vehicle 12 and transferred to the grid when the vehicle 12 is connected to the service terminal 14.

The system 10 is particularly suitable for providing services to fuel cell and regenerative fuel cell vehicles, but can also serve vehicles powered by other means, such as natural gas, electricity, etc. The vehicle 12 has a number of components that make it compatible with the service terminal; the type of components depend on what services are being transferred.

FIG. 1 illustrates a system 10 that transfers gaseous fuel between the vehicle 12 and the service terminal 14. The gaseous fuel may be hydrogen. The vehicle 12 is suitably any known vehicle that can operate on gaseous fuels, such as fuel cell vehicles (FCV), regenerative fuel cell vehicles (RFCV), and internal combustion engine vehicles (ICEV). The vehicle 12 includes a gaseous fuel compatible engine 20, and a gas storage cylinder 22 fluidly connected to the engine 20 and the connectivity device 500 by a gas line 24. The connectivity device 500 has a gas transfer port (not shown) that is sealably connectable to a gas transfer port (not shown) of the wheel stop service port 400 to enable the transfer of gas between the vehicle 12 and the service terminal 14. Optionally, a gas reformer 26 is provided that is connected to the connectivity device 500 and the gas storage cylinder 22 via another gas line 28, so that gaseous fuel transmitted from the wheel stop service port 400 can be first reformed before being stored in the gas storage cylinder 22 and used by the engine 20. Gas line 24 is bi-directional to enable fuel to be transmitted from the service terminal 14 to the vehicle 12, or vice versa.

The connectivity device 500 is electrically communicative with a vehicle controller 30 via control signal wire 32, which controls operation of the connectivity device 500; for example, the vehicle controller 30 provides automatic connection and gas transfer control signals to control the transfer of gaseous fuel through the connectivity device 500. The vehicle controller 30 has a transceiver (not shown) to exchange data wirelessly with a transceiver (not shown) in a service port controller 34 of the service terminal 14 (wireless link shown as 35). The construction of the controllers 30, 34 are known in the art. Optionally, a wired data link 37 may be substituted for the transceivers; in such case, data line connection points (not shown) are provided on each of the wheel stop service port 400 and the connectivity device 500 that connect when the wheel stop service port 400 and the connectivity device 500 are coupled or alternatively data can be sent over the electrical power connections. The data communicated to and from the vehicle controller 30 relates to providing data-related services that include vehicle identification, and fueling processes.

The port service conduit 36 is fluidly connected to the wheel stop service port 400 and an off-vehicle fuel source/destination, and is electrically connected to the wheel stop service port 400 and the service port controller 34. Optionally, a control signal wire 38 may be provided to link the service port controller 34 directly to the wheel stop service port 400 and enable direct communication between the two components. The port service conduit 36 may be fluidly connected to storage tanks (not shown) of the service terminal 14 that may be supplied fuel from time to time by refueling tankers (not shown), or to a fluid pipeline (not shown) in a gas distribution network (not shown) for the continuous supply of fuel.

FIG. 2 illustrates a system 10 that transfers electrical energy between the vehicle 12 and the service terminal 14, wherein the vehicle 12 is a battery-powered electric vehicle (BPEV). The vehicle 12 therefore differs from the vehicle shown in FIG. 1 in that a power converter 40, battery 42 and electrical cables 44 replace the gas storage cylinder 22 and gas lines 24. Furthermore, the engine 20 is an electric motor, and the connectivity device 500 is configured to transmit electric power between the service terminal 14 and the vehicle 12, and the vehicle controller 30 is configured to control the transmission of electrical energy by the connectivity device 500. Electrical cables 44 electrically couple the connectivity device 500, power converter 40, battery 42, and the engine 20. Similarly, the wheel stop service port 400 is configured to transmit electric power between the service terminal 14 and the vehicle 12, and the service port controller 34 is configured to control the transmission of energy by the wheel stop service port 400.

FIG. 3 illustrates a system 10 that transfers liquid fuel between the service terminal 14 and the vehicle 12. The liquid fuel may be fuel that is directly combustible by a conventional internal combustion engine, or be reformed into hydrogen reformate for use by a fuel cell. The vehicle 12 therefore differs from the vehicle shown in FIG. 1 in that a liquid fuel storage tank 23 and liquid fuel lines 25 are designed to store and transmit liquid fuel as known in the art. Furthermore, the engine 20 is an internal combustion engine if the fuel is to be directly combusted, or a fuel cell if the fuel is reformate (in such case, a reformer (not shown) is provided to reform the fuel into hydrogen reformate and reaction products, and a scrubber is provided (not shown) to clean the fuel sufficiently for use by the fuel cell) and the connectivity device 500 is configured to transfer liquid fuel between the service terminal 14 and the vehicle 12, and the vehicle controller 30 is configured to control the transmission of liquid by the connectivity device 500. Similarly, the wheel stop service port 400 is configured to transmit liquid fuel between the service terminal 14 and the vehicle 12, and the service port controller 34 is configured to control the transmission of liquid fuel by the wheel stop service port 400.

FIG. 4 illustrates a system 10 that transfers water and electrical energy between the service terminal 14 and the vehicle 12. The water is electrolyzed on-board the vehicle 12 to generate hydrogen fuel. The vehicle 12 therefore differs from the vehicle shown in FIG. 1 in that a liquid storage tank 27 is provided to store water transferred from the service terminal 14, an electrolyzer 46 is provided to electrolyze the water to produce hydrogen gas, and a gas storage cylinder 22 is provided to store the hydrogen gas for use by the engine 20. Hydrogen fuel lines 21 fluidly connect the gas storage cylinder 22 to the electrolyzer 46 and engine 20 respectively, and fluid supply and return lines 50, 51 fluidly connect the fluid storage tank 27 to the connectivity device 500 and the electrolyzer 46 respectively. Water is supplied to the vehicle 12 as hydrogen feedstock for the electrolyzer 46 via liquid supply line 50, and unused water from the electrolyzer 46 is returned through liquid return line 51. Water line 53 connects the liquid storage tank 27 to the engine 20 to return product water from the engine 20 and to supply water to humidify the gas stream. Both the connectivity device 500 and the wheel stop service port 400 are configured to transfer liquid and electricity between the service terminal 14 and the vehicle 12. Electrical cables 44 electrically connect the connectivity device 500 to the electrolyzer 46. The vehicle controller 30 is configured to control the operation of the connectivity device 500 to transfer water and electricity for the operation of the electrolyzer 46. The vehicle controller 30 is electrically communicative with the connectivity device 500 via control signal wire 32 and with the electrolyzer 46 via electrical connector 33. The service port controller 34 is configured to control the operation of the wheel stop service port 400 to transfer water and electricity. The service port controller 34 is electrically communicative with the wheel stop service port 400 via the port service conduit 36. Optionally, the controller 34 may include control signal wires 38 connected directly to the wheel stop service port 400 to provide liquid and electricity transfer control signals to control the transfer of liquids and electricity through the wheel stop service port 400.

In operation, water is transferred to the vehicle 12 through the wheel stop service port 400 and through the coupled connectivity device 500 and then stored in the liquid storage tank 27. The water is then transferred to the electrolyzer 46 and transformed to gaseous hydrogen by-product which is transferred to gas storage cylinders 22 through gas line 24. Electricity is transferred through the wheel stop service port 400 and the connectivity device 500 and to the electrolyzer 46 to power the electrolysis process. Alternatively, water is transferred to the vehicle 12 through the wheel stop service port 400 and through the coupled connectivity device 500 directly to the electrolyzer 46.

FIG. 5 illustrates a system 10 that is capable of transferring one or more of gaseous and liquid fuel, electrical energy and data between the service terminal 14 and the vehicle 12. The vehicle 12 may include some or all of the components as described in the systems illustrated in FIGS. 1 to 4. The connectivity device 500 may include one or a combination of the service connections as described in the previous systems. For this embodiment, the wheel stop service port 400 has interfaces for at least gaseous fuel, liquid, electricity and data. The wheel stop service port 400 is suitable to work with the connectivity device 500 of any of the vehicles described in FIGS. 1 to 4, regardless of the maximum number of service connections on the connectivity device 500. An additional function of the system 10 is that the type of connectivity device 500 and the type of service required is determined by communication between the vehicle controller 30 and the service port controller 34. The service port controller 34 provides control signals through the control signal wire 38 to the wheel stop service port 400 directly, or via control signal wire 39 and port service conduit 36 to control the transfer of only those services suitable for the identified connectivity device 500.

Additional features may be incorporated into any of the service terminals 14 that utilize water flow, such as an integrated pressure relief valve (not shown) and/or flow limiting device (not shown) connected in-line to the fluid lines 50 for the purpose of restricting fluid flow. These components reduce the risk and scale of problems caused by fluid delivery component (not shown) failures by restricting or redirecting fluid flow, as would be understood by one skilled in the art.

Water quality control features may be incorporated into any of the service terminals 14 that utilize water flow, such as an integrated filter (not shown) connected of the fluid lines 50 for the purpose of treatment to remove contaminants (particulates, etc.) and/or to de-ionize the water. The treatment of the delivered water maintains the cleanliness of the connection bay 406, the connectivity device 500 and enhances the operation of the electrolyzer 46 and fuel cells.

An optional method of connecting the fluid line 50 from the wheel stop service port 400 to the connectivity device 500 of the system 10 of FIGS. 4 and 5 is to include a self-sealing permeable or semi-permeable membrane (not shown) in the water flow path for water transfer. The advantage of this feature is to provide self-sealing and water filtering when the connection is made.

Referring to FIG. 6, the wheel stop service port 400 serves as a ground-mounted stationary docking location for vehicles 12 equipped with compatible connectivity devices 500. Such vehicles 12 couple to the wheel stop service port 400 and bi-directionally transfer services between the service terminal 14 and the vehicle 12. As mentioned, these services include electrical power, gaseous or liquid fuels, water, or data. The wheel stop service port 400 is also designed to prevent the wheels of the vehicle 12 from traveling beyond a specific point in a parking stall and to locate the vehicle 12 in a position that places the vehicle's connectivity device 500 in a position for coupling to the service port 400.

According to one embodiment of the invention, the wheel stop service port 400 has a generally elongate rectangular wheel stop housing 401 with fastening holes 402. The fastening holes receive a fastener (not shown) for fastening the service port 400 to a parking surface. Near the center of the front surface of the housing 401 is a recess opening 411 that opens into a receptacle recess 409. A connection bay 406 and a receptacle 405 are mounted inside the receptacle recess 409. The connection bay 406 has a front opening in the shape of a rectangular slot, and has walls 426 that taper inwards both vertically and horizontally into the receptacle 405. The front opening of the connection bay 406 is flush with the recess opening 411. The receptacle 405 is mounted inside the receptacle recess 409 behind the connection bay 406 and also has tapered walls 626 (shown in FIG. 16) that taper into the back wall of the receptacle 405. As discussed in detail below, the tapered walls 426, 626 serve to guide a service plug 502 from the vehicle's connectivity device 500 into a coupling position inside the receptacle 405, i.e. into a position where the plug 502 contacts the back wall of the receptacle 405.

In this description, the receptacle 405 and plug 502 are collectively referred to as a “service coupling”. Furthermore, the connection bay 406 and receptacle 405 are collectively referred to as the “connection bay assembly”.

The tapered walls 426, 626 act to guide, or “self locate” the plug 502 into a coupling position, thereby removing the need to provide costly electronic coupling guidance systems. It is understood that other self-locating designs such as a funnel may be substituted for the tapered walls 426, 626 as will occur to one skilled in the art.

The service port 400 is externally controlled by the service port controller 34 via a signal conduit housed inside the service conduit 36. An externally controlled receptacle 405 allows system intelligence such as the service port controller 34 to be located elsewhere enabling the service port 400 to serve as a “dumb terminal” that can be economically and easily replaced. Optionally, the service port 400 also has a port status indicator 408 located on the top surface of the housing 401. The indicator 408 is electrically communicative with the receptacle 405, or optionally with the port controller 34 to receive status control signals, e.g. a port failure status control signal.

The recess opening 411 is located on the front wall of the service port 400 but it may be located anywhere on the wheel stop housing 401. For example, the recess opening 411 may open from the top surface of the housing 401 such that the receptacle 405 and connection bay 406 receive a vertically deployed connectivity device 500.

The receptacle 405 is provided with service exchange interfaces that mate with corresponding service exchange interfaces on the plug 502, to effect a transfer of services therebetween. The service conduit 36 is coupled to the receptacle 405 at the back of the service port 400 and to service sources and/or destinations, thereby enabling the services to be transferred to and from the service port 14 and the service source/destination.

In an alternative embodiment, the service terminal 14 does not include the wheel stop service port 400 and in such case, a service port comprising the connection bay 406 and receptacle 405 are located elsewhere on the service terminal 14, and the corresponding location of the connectivity device 500 on the vehicle 12 of the alternative embodiment, is at a position for coupling to the service port 400.

Referring to FIG. 7, the connectivity device 500 is for connecting the vehicle 12 to the service terminal 14 such that services can be exchanged therebetween. In this first embodiment, the connectivity device 500 is mountable to the front underside of the vehicle 12, has a motorized mechanism to deploy the connectivity device 500 from the vehicle 12, and has a plug 502 to couple to the receptacle 405 on the wheel stop service port 400 when the vehicle 12 is in close proximity to the wheel stop service port 400. However, it is within the scope of the invention to locate the connectivity device 500 on the wheel stop service port 400, and locate the receptacle 405 on the vehicle 12; in such case, the connectivity device 500 extends from the wheel stop service port 400 to couple to the vehicle 12 when the vehicle 12 is in close proximity to the wheel stop service port 400.

The major components of the connectivity device 500 are a plug 502 for coupling to the receptacle 405 of the service terminal 14, a compliant member 504 attached at one end to the plug 502, a deployment apparatus 510 attached to the compliant member 504 for deploying the plug 502 from a stored position into a deployed position and retracting same back into the stored position, and a vehicle mounting assembly 512 attached to the deployment apparatus 510 and couplable to the underside of the vehicle 12.

The compliant member 504 comprises a pair of flexible tubular fluid lines 514 and a flexible electrical cable 516 having a plurality of flexible electrical power conductors (not shown) housed within a protective jacket. The fluid lines 514 and the power conductors are coupled to components of the vehicle 12 that use or supply electricity and/or a fluid such as water. For example, the fluid lines 514 and electrical cables may be connected to the on-board electrolyzer 46 to supply feedstock fluid and power the electrolyzer 46, respectively. In this embodiment, the fluid lines 514 are used to transfer water, however, it is to be understood that other fluids such as hydrogen can be transferred by the fluid lines 514.

A suitable electrical cable 516 and power conductor combination is a flat festoon cable such as Siemens Planoflex power cable having four conductors covered by a Neoprene jacket. However, other materials having similar properties may be used, as will occur to one skilled in the art.

The fluid lines 514 are made of an elastomer reinforced with woven metal or synthetic fabric; this material is selected to provide sufficient flexibility, pressure resistance, and fluid compatibility. A suitable fluid line is flexible Kynar®) Polyvinylidene Fluoride (PVDF) tubing 0390.016. However, other similar tubing may be used as will occur to one skilled in the art.

For a connectivity device 500 configured to transfer hydrogen gas between the vehicle 12 and service terminal 14, the compliant member may also include a flexible hydrogen conduit (not shown). A suitable flexible hydrogen conduit has an electrically conductive polymer core tube with fiber reinforcement and a urethane cover, such as Parker Panflex 5CNGFR-4. However, other similar tubing may be used as will occur to one skilled in the art.

Referring to FIG. 8, the deployment apparatus 510 includes a cable clamp 518 that securely clamps around the electrical cable 516. The cable clamp 518 is slidably attached to a pair of horizontal guide rails 520, and is movable along the guide rails 520 by a pair of horizontal translation screws 522. The horizontal guide rails 520 are attached at their distal end to a stopper 524 and at their proximal end to a mounting frame 526. The stopper 524 prevents the cable clamp 518 from extending beyond the horizontal guide rails 520. Also attached to the mounting frame 526 is a horizontal drive motor 528, which drives a horizontal drive shaft 530, which in turn drives the horizontal translation screws 522 to move the clamped electrical cable 516 along the guide rails 520. The horizontal drive motor 528 is electrically connected to an electrical power supply (not shown) and is electrically communicative with the vehicle controller 30. The components attached to the mounting frame 526 that translate the compliant member 504 along the horizontal axis are collectively referred to as the “horizontal extension arm”. Note that the use of “horizontal” is for reference purposes only and that the position of the horizontal extension arm does not have to be horizontal relative to the environment.

Also extending from the mounting frame 526 in a perpendicular direction from the horizontal guide rails 520 is a vertical extension arm comprising an outer tube 532 attached at its bottom end to the frame 526, and an inner tube 534 vertically slidable within the outer tube 532 and having its top end attached to the vehicle mounting assembly 512. Referring to FIG. 9, a vertical translation screw 536 extends inside the inner and outer tubes 534, 532 and attaches at its top end to the vehicle mounting assembly 512. The other end of the screw 536 is rotatably connected to a vertical drive assembly (not shown), which in turn is rotatably attached to a vertical drive motor 538 attached to the mounting frame 526. The vertical drive motor 538 is electrically connected to a power supply (not shown) and electrically communicative with the vehicle controller 30, and can be operated to vertically move the vertical extension arm. Note that the use of “vertical” is for reference purposes only, and that the position of the vertical extension arm does not have to be vertical relative to the environment.

The inner tube 534 is rotatable relative to the outer tube 532; the range of rotation is defined by a cam slot 540 on the surface of the inner tube 534 and a vertical guide rail 542 fixed to the mounting frame 526 and having a cam follower 541 protruding through the cam slot 540. The cam slot 540 is wider at its bottom than at its top; this enables the connectivity device 500 to have a greater range or rotation when fully deployed than when retracted. A coil spring 544 attached to the vehicle mounting assembly 512 and vertical drive assembly and biases the cam follower 541 in the middle of the cam slot 540 and allows the horizontal extension arm to rotate about the vertical extension arm within the dimensions of the cam slot 540.

Referring again to FIGS. 7 and 8, cleaning brushes 546 may be provided on the horizontal extension arm and around the compliant member 504 to clean the surface of the compliant member 504 when it retracts inside the deployment apparatus 510. The cleaning brushes 546, horizontal guide rails 520, horizontal translation screws 522, stopper 524 and cable clamp 518 are all enclosed in a horizontal extension arm cover 449. The vertical and horizontal drive motors 538, 528 are covered by a drive motor cover 548.

Referring to FIGS. 10 and 11, the connectivity device 500 is stored in a storage bay 550 when the connectivity device 500 is fully retracted. The storage bay 550 has fasteners 552 for mounting the storage bay 550 to the underside of the vehicle 12. When the connectivity device 500 is deployed, the horizontal extension arm first retracts until the plug 502 is freed from the storage bay 550, then the vertical and horizontal extension arms are extended to move the connectivity device 500 into its deployed position.

Referring to FIG. 13, springs 560 may be provided at each corner of a mounting plate 562 of the vehicle mounting assembly 512. Alternatively, as shown in FIG. 14, the four springs 560 may be substituted by one larger spring 564 mounted at the middle of the mounting plate 562.

Referring to FIGS. 6 and 12, the plug 502 and receptacle 405 are coupled as follows: The vehicle 12 is driven into a service terminal docking position and parked such that the front wheels of the vehicle 12 make contact with the wheel stop housing 401. Markings may be provided on the a wheel stop contact surface 103 of the housing 401 or elsewhere on the service terminal 14 to provide a visual guide for the driver to park the vehicle 12 so that the connectivity device 500 is aligned with the receptacle 405. The wheel contact surface 103 is located on the housing surface such that the aligning of the wheels with the wheel contact portion aligns the connectivity device 500 with the recess opening 411.

When the vehicle 12 is perfectly aligned with the wheel stop service port 400, the deployed connectivity device 500 passes through the middle of the connection bay 406 opening without contacting the connection bay 406 or receptacle 405 before the plug 502 enters the receptacle 405. The plug 502 is in place for coupling to the receptacle 405 when it contacts both sides of the receptacle tapered walls 426.

When the vehicle 12 is not perfectly aligned but still within range of the connection bay 406, a service connection can still be established as the connectivity device 500 comprises compliant components that enable the connectivity device 500 to comply with the shape of the receptacle 405 and connection bay 406 and deliver the plug 502 into the receptacle 405. FIGS. 15 to 17 illustrate the steps of coupling the plug 502 with the receptacle 405 when the vehicle 12 is not perfectly aligned but still within range of the wheel stop service port 400. After the vehicle 12 has parked, the connectivity device 500 is deployed; being misaligned, the plug 502 first makes contact with one or more tapered walls 426, 626 of the connection bay 406 or receptacle 405. As the connectivity device 500 continues to deploy, the load exerted on the plug 502 against the tapered wall(s) 426, 626 exceeds a compliant member threshold value (dependent on the physical characteristics of the compliant member 504, e.g. stiffness of fluid hoses, electrical cable) and the compliant member 504 flexes, causing the plug 502 to slide along the wall and towards the receptacle 405. The connectivity device 500 deployment continues until the plug 502 is guided into an engagement position in the receptacle 405. Optionally, one of the tapered walls 426, 626 or plug 502 may have a low friction coating which enhances the sliding of the plug, particularly after repeated use.

While the compliant member 504 is flexible from side to side and up and down, other parts of the connectivity device 500 also provide additional compliance in those directions. For example, when the connectivity device 500 is located too far to either side of the receptacle 405 (but still within the boundaries of the connection bay opening), the horizontal extension arm may rotate about the vertical extension arm. And, if the connectivity device 500 is located too far above or below the receptacle 405 (but still within the boundaries of the connection bay opening), the springs 560, 564 (shown in FIGS. 13 and 14 respectively) can provide additional compliance in the vertical direction, as well as in yaw, pitch and roll.

The compliant nature of the connectivity device 500 enables it to comply with the shape of the connection bay 406 such that the plug 502 is passively guided into the receptacle 405. So long as the connectivity device 500 is within range (is extendible within the boundaries of the connection bay opening), the vehicle 12 is able to “passively dock” with the service port 14 without the requirement for actively controlled docking equipment that detects the position of the parked vehicle 12 and moves the connectivity device 500 into alignment with the receptacle 405. Such actively controlled docking equipment is expected to include proximity sensors, actuators, etc., and would add complexity and cost to the connectivity device 500.

In addition to enabling the connectivity device 500 on a misaligned vehicle 12 to establish a service connection, the compliant components also enable the coupled plug 502 and receptacle 405 to maintain a service connection when the position of the connectivity device 500 changes, e.g. if the vehicle's ride height is changed by loading or unloading of the vehicle 12.

The deployment position of the connectivity device 500 may be pre-selected based on a consideration of certain factors such as the vehicle ground clearance and the height of the wheel stop service port 400, which in this example would be provided as feedback data to either the vehicle controller 30 or connectivity device controller (not shown). In the interest of simplicity and low-cost, once the height of the vehicle 12 and other relevant factors are considered, the vertical extension is programmed into the vehicle controller 30 and the vehicle controller 30 instructs the connectivity device 500 to deploy to this pre-selected position on every occasion. This is suitable for connecting to service terminals that have all connection bays 406 at the same elevation. A more sophisticated but complicated design may be applied where the connection bay 406 elevation varies between different models of service terminals. In such case, the vehicle controller 30 may be programmed with the connection bay 406 elevation of various service terminal models, and deploy the connectivity device 500 to a height that corresponds to the particular service terminal model that the vehicle 12 is connecting to.

In an alternative embodiment of the invention, the length of the electrical cable 516 is reduced by providing means for conducting electrical power between the plug 502 and the vehicle 12 via cable conductors in a shortened electrical cable 516 and conductive elements in the deployment apparatus 510. In this alternative embodiment, the electrical cable 516 extends between the plug 502 and the cable clamp 518, and the deployment apparatus 510 is provided with conductive horizontal translation screws 522, and means to electrically couple the screws 522 to the cable conductors to the electrical cable 516. The proximal ends of the screws 522 are electrically coupled to a conductive element in the vertical extension arm, which in turn is electrically coupled to conductors in the vehicle 12.

One means for electrically coupling the cable conductors to the conductive screws 522 is by a conductive lug nut (not shown) that is physically and electrically connected to the proximal end of the cable conductors as well as to electrically conductive strips (not shown) on the cable clamp 518; the conductive strips are also electrically coupled to the screws 522 thereby providing an electrical path between the plug 502 and the deployment apparatus 510. Instead of conductive strips, the cable clamp 518 may be manufactured from an electrically conductive material, and be connected to the lug nut and screws 522 such that an electrical path is provided between the plug 502 and the deployment apparatus 510.

Referring to FIGS. 18 and 19, instead of conductive lead screws 522, a sliding contact assembly 570 may be provided to conduct electricity between the plug 502 and the vehicle 12. The sliding contact assembly 570 comprises an electrical contact 572 physically attached to the cable clamp 518 and having one end electrically coupled to the cable conductor, and another end in sliding contact with an electrical contact strip 574 attached to and extending along the length of the inside surface of the horizontal deployment arm of the connectivity device 500. The electrical contact strip 574 is electrically coupled to a conductive element in the vertical extension arm which in turn is electrically coupled to conductors in the vehicle 12. The sliding contact assembly may also comprise a housing (not shown) around the sliding contact zone, to protect the contact assembly from contamination and other damage.

Referring to FIGS. 20 and 21, in another alternative embodiment of the invention, a telescoping tube assembly 580 is used to transfer a fluid such as hydrogen gas through the connectivity device 500. The telescoping tube assembly 580 comprises a telescoping tube 582, a sliding seal 584 slidably and sealingly attached to the tube 582 and that prevents leakage of fluid flowing through the tube 582, and a telescoping mechanism movably attached to the tube 582 for extending and retracting the tube 582. The telescoping mechanism may be a hollow screw mechanism 586 mounted concentrically within the telescoping tube 582, or may be a pair of screws (not shown) mounted on either side of the telescoping tube 582. The screw(s) 586 is driven by an electric motor 588 and is movably connected to the tube 582 such that rotation and counter-rotation of the screw 586 causes the tube 582 to extend and retract. The tube 582 comprises a plurality of tubular segments in concentric sliding contact, and is constructed of a material and is sealed by a sliding seal such that a fluid such as hydrogen gas may be passed through the tube 582 without leaking. The tube assembly 580 may also include a protective cover (not shown) to protect the outside sealing surface of the tube 582 from damage and contamination during operation. A gas sensor (not shown) may be installed near the tube 582 to detect gas leakage.

One end of the tube 582 (distal end) is fluid connected to a fluid transfer conduit (not shown) that terminates in a fluid transfer port and valve assembly (not shown) in the plug 502. The other end of the tube 582 (proximal end) is fluid connected to another fluid transfer conduit (not shown) that terminates in a fluid transfer port and valve assembly (not shown) at an interface between the connectivity device 500 and the vehicle 12, e.g. at the vehicle mounting assembly 512. Both fluid conduits may be made of a flexible material to provide compliance and/or enable the connectivity device 500 to move between stored and deployed positions.

While the preferred embodiment of the invention has been illustrated and described, it will be appreciated that various changes can be made therein without departing from the scope and spirit of the invention.

1. A connectivity device for connecting a vehicle to a service terminal, comprising
(a) a mount for mounting the connectivity device to one of the vehicle and the service terminal;
(b) a deployment apparatus movably attached to the mount;
(c) a plug for coupling to a receptacle in the other of the vehicle and the service terminal; and,
(d) a compliant member attaching the plug to the deployment apparatus, the compliant member providing sufficient compliance for the plug to engage the receptacle after movement by the deployment apparatus and when the connectivity device is in range of but not perfectly aligned with the receptacle.

2. The connectivity device of claim 1 wherein the mount is configured to mount to the vehicle, and the receptacle is configured to mount to the service terminal.

3. The connectivity device of claim 2 wherein the compliant member is elongate, having a distal end attached to the plug.

4. The connectivity device of claim 3 wherein the compliant member comprises a flexible electrical conductor electrically coupled at one end to the plug and couplable at the other end to the vehicle.

5. The connectivity device of claim 4 wherein the compliant member further comprises a flexible fluid conduit fluid coupled at one end to the plug and couplable at the other end to the vehicle.

6. The connectivity device of claim 5 wherein the fluid conduit is a water conduit.

7. The connectivity device of claim 5 wherein the fluid conduit is a hydrogen gas conduit.

8. The connectivity device of claim 2 wherein the compliant member comprises a flexible festoon cable comprising an electrical conductor electrically coupled at one end to the plug and electrically couplable at the other end to the vehicle, and a jacket housing the conductor.

9. The connectivity device of claim 8 wherein the compliant member further comprises a flexible fluid conduit fluidly coupled at one end to the plug, and fluidly couplable at the other end to the vehicle.

10. The connectivity device of claim 9 wherein the fluid conduit is flexible Polyvinylidene Fluoride (PVDF) tubing.

11. The connectivity device of claim 2 wherein the mount comprises a mounting plate and a mount compliant member attached to the mounting plate and attachable to the vehicle.

12. The connectivity device of claim 11 wherein the mount compliant member comprises at least one spring.

13. The connectivity device of claim 2 further comprising a docking bay attachable to the vehicle and for storing the plug when the connectivity device is in a retracted position.

14. The connectivity device of claim 2 further comprising an internal controller communicative with the deployment apparatus and one of a wireless transceiver and vehicle controller, for controlling the movement of the deployment apparatus.

15. The connectivity device of claim 1 wherein the compliant member extends between the plug and the deployment apparatus, and wherein the compliant member comprises an electrical conductor electrically coupled to the plug, the deployment apparatus includes a conductive screw electrically coupled to the conductor and couplable to the vehicle, such that an electrical path is formed between the plug and the deployment apparatus.

16. The connectivity device of claim 1 wherein the compliant member extends between the plug and the deployment apparatus, the compliant member includes an electrical conductor electrically coupled to the plug, the deployment apparatus comprises a conductive strip electrically couplable to the vehicle and a contact element in sliding contact with the strip and electrically coupled to the compliant member conductor.

17. The connectivity device of claim 1 further comprising a telescoping fluid tube assembly that is fluid coupled at one end to the plug and fluid couplable at the other end to the vehicle, such that a fluid is transferable through the connectivity device.

18. A connectivity device for connecting a vehicle to a service terminal, comprising
(a) a mount assembly comprising a mount and a mount compliant member attached to the mount, the mount assembly for mounting the connectivity device to one of the vehicle and the service terminal;
(b) a deployment apparatus movably attached to the mount;
(c) a plug for coupling to a receptacle in the other of the vehicle and the service terminal;
(d) a plug compliant member attaching the plug to the deployment apparatus,
the plug and mount compliant members providing sufficient compliance for the plug to engage the receptacle after movement by the deployment apparatus and when the connectivity device is in range of but not perfectly aligned with the receptacle.

19. The connectivity device of claim 18 wherein the mount assembly is configured to mount to the vehicle, and the receptacle is configured to mount to the service terminal.

20. The connectivity device of claim 19 wherein the compliant member is elongate, having a distal end attached to the plug.

21. The connectivity device of claim 20 wherein the compliant member comprises a flexible electrical conductor electrically coupled at one end to the plug and couplable at the other end to the vehicle.

22. The connectivity device of claim 21 wherein the compliant member further comprises a flexible fluid conduit fluid coupled at one end to the plug and couplable at the other end to the vehicle.

23. The connectivity device of claim 22 wherein the fluid conduit is a water conduit.

24. The connectivity device of claim 22 wherein the fluid conduit is a hydrogen gas conduit.

25. The connectivity device of claim 22 wherein the compliant member comprises a flexible festoon cable comprising an electrical conductor electrically coupled at one end to the plug and electrically couplable at the other end to the vehicle, and a jacket housing the conductor.

26. The connectivity device of claim 25 wherein the compliant member further comprises a flexible fluid conduit fluid coupled at one end to the plug, and fluidly couplable at the other end to the vehicle.

27. The connectivity device of claim 26 wherein the fluid conduit is flexible Polyvinylidene Fluoride (PVDF) tubing.

28. The connectivity device of claim 18 wherein the mount compliant member comprises at least one spring.

29. The connectivity device of claim 19 further comprising a docking bay attachable to the vehicle and for storing the plug when the connectivity device is in a retracted position.

30. The connectivity device of claim 18 further comprising an internal controller communicative with the deployment apparatus and one of a wireless transceiver and vehicle controller, for controlling the movement of the deployment apparatus.

31. The connectivity device of claim 18 wherein the compliant member extends between the plug and the deployment apparatus, and wherein the compliant member comprises an electrical conductor electrically coupled to the plug, the deployment apparatus comprises a conductive screw electrically coupled to the conductor and couplable to the vehicle, such that an electrical path is formed between the plug and the deployment apparatus.

32. The connectivity device of claim 18 wherein the compliant member extends between the plug and the deployment apparatus, the compliant member comprises an electrical conductor electrically coupled to the plug, the deployment apparatus comprises a conductive strip electrically couplable to the vehicle and a contact element in sliding contact with the strip and electrically coupled to the compliant member conductor.

33. The connectivity device of claim 18 further comprising a telescoping fluid tube assembly that is fluid coupled at one end to the plug and fluid couplable at the other end to the vehicle, such that a fluid is transferable through the connectivity device.

34. A system for connecting a vehicle to a service terminal, comprising
(a) a connection bay assembly in one of the vehicle or service terminal, and including
i. a connection bay including a connection bay opening, a receptacle opening, and tapered walls tapering from the connection bay opening to the receptacle opening; and,
ii. a receptacle connected to the receptacle opening; and
(b) a connectivity device in the other of the vehicle or service terminal, and including
i. a mount for mounting the connectivity device to the other of the vehicle and the service terminal;
ii. a deployment apparatus movably attached to the mount;
iii. a plug for coupling to the receptacle; and,
iv. a compliant member attaching the plug to the deployment apparatus, the compliant member providing sufficient compliance for the plug to comply with the tapered walls then engage the receptacle after movement by the deployment apparatus and when the connectivity device is in range of but not perfectly aligned with the receptacle.

35. The connectivity device of claim 34 wherein the mount is configured to mount to the vehicle, and the receptacle is configured to mount to the service terminal.

36. The connectivity device of claim 35 wherein the compliant member is elongate, having a distal end attached to the plug.

37. The connectivity device of claim 36 wherein the compliant member comprises a flexible electrical conductor electrically coupled at one end to the plug and couplable at the other end to the vehicle.

38. The connectivity device of claim 37 wherein the compliant member further comprises a flexible fluid conduit fluid coupled at one end to the plug and couplable at the other end to the vehicle.

39. The connectivity device of claim 38 wherein the fluid conduit is a water conduit.

40. The connectivity device of claim 38 wherein the fluid conduit is a hydrogen gas conduit.

41. The connectivity device of claim 35 wherein the compliant member comprises a flexible festoon cable comprising an electrical conductor electrically coupled at one end to the plug and electrically couplable at the other end to the vehicle, and a jacket housing the conductor.

42. The connectivity device of claim 41 wherein the compliant member further comprises a flexible fluid conduit fluidly coupled at one end to the plug, and fluidly couplable at the other end to the vehicle.

43. The connectivity device of claim 42 wherein the fluid conduit is flexible Polyvinylidene Fluoride (PVDF) tubing.

44. The connectivity device of claim 35 wherein the mount comprises a mounting plate and a mount compliant member attached to the mounting plate and attachable to the vehicle.

45. The connectivity device of claim 44 wherein the mount compliant member comprises at least one spring.

46. The connectivity device of claim 35 further comprising a docking bay attachable to the vehicle and for storing the plug when the connectivity device is in a retracted position.

47. The connectivity device of claim 34 further comprising an internal controller communicative with the deployment apparatus and one of a wireless transceiver and vehicle controller, for controlling the movement of the deployment apparatus.

48. The connectivity device of claim 34 wherein the compliant member extends between the plug and the deployment apparatus, and wherein the compliant member comprises an electrical conductor electrically coupled to the plug, the deployment apparatus comprises a conductive screw electrically coupled to the conductor and couplable to the vehicle, such that an electrical path is formed between the plug and the deployment apparatus.

49. The connectivity device of claim 34 wherein the compliant member extends between the plug and the deployment apparatus, the compliant member comprises an electrical conductor electrically coupled to the plug, the deployment apparatus comprises a conductive strip electrically couplable to the vehicle and a contact element in sliding contact with the strip and electrically coupled to the compliant member conductor.

50. The connectivity device of claim 34 further comprising a telescoping fluid tube assembly that is fluid coupled at one end to the plug and fluid couplable at the other end to the vehicle, such that a fluid is transferable through the connectivity device.
